(19) United States
(12) Patent Application Publication
(10) Pub. No.: US 2008/0153057 A1
(43) Pub. Date: Jun. 26, 2008

(54) Awake airway: non-stimulating (non-gagging) feature

(76) Inventor: Charles Craig Baldwin, Columbia, MD (US)

Correspondence Address: CHARLES C. BALDWIN, 5000 Dustin Court, Columbia, MD, 65203, US

(21) Appl. No.: 11/602,920

(22) Filed: Dec. 22, 2006

(51) Int. Cl. A61C 5/00; A61C 5/14

(52) U.S. Cl. 433/140; 128/861

(57) ABSTRACT

The Awake Airway is an oral device designed with two arches to gently hold both the maxillary and mandibular dental arches in a fixed position angled slightly open in such a way as to not stimulate any part of the oral cavity or oropharynx so a fully wide awake user would tolerate it. It would be made of a resilient material such as a soft plastic with a foam insert to hold the teeth or edentulous arches. It is shaped to conform to the teeth and maxillary and mandibular anatomy, and easily inserted by the user him/herself. By gently maintaining the mouth slightly open it would enhance the patency of the airway. It's usefulness would include that of a clinical airway in awake to sedated or anesthetized or obtunded patients that may be more flexible than currently available airway support devices since it may be tolerated until the user is fully awake. Another use might be in Obstructive Sleep Apnea (OSA) as the patient may place it themselves and tolerate it as they sleep with airway support that could supplement or replace current therapies.

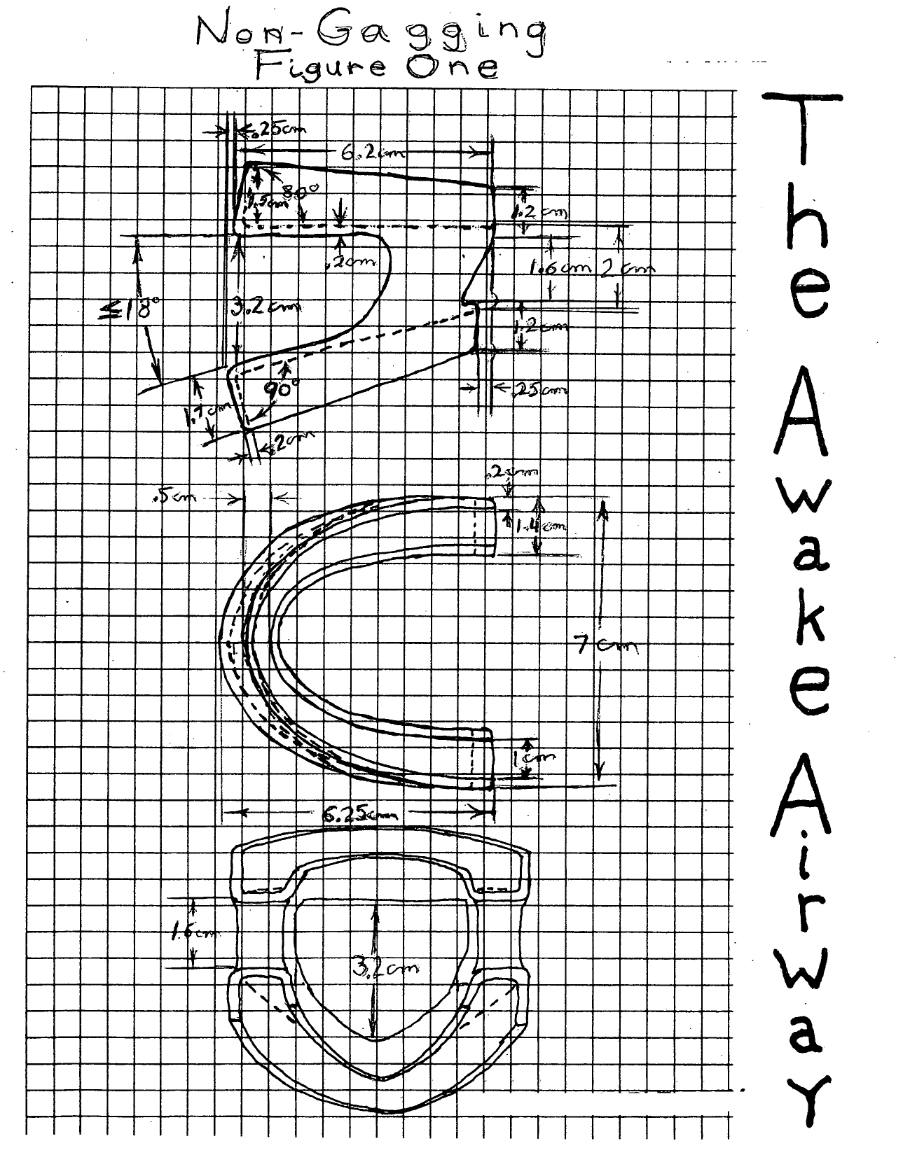

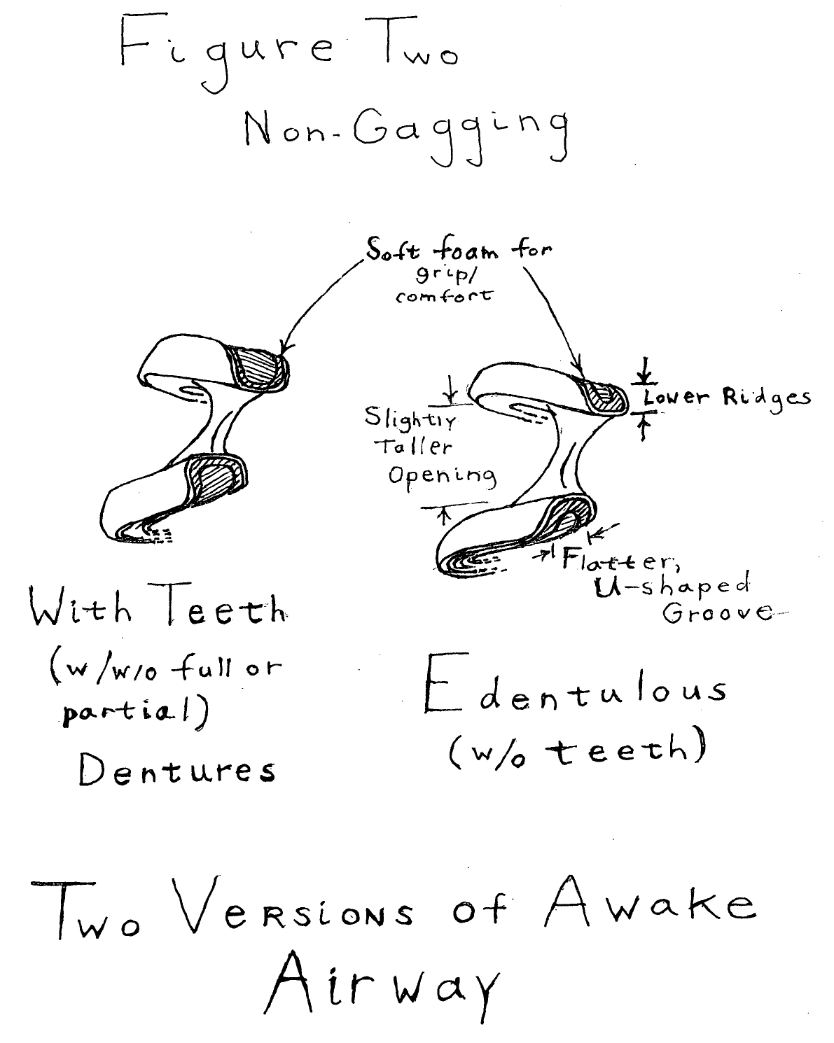

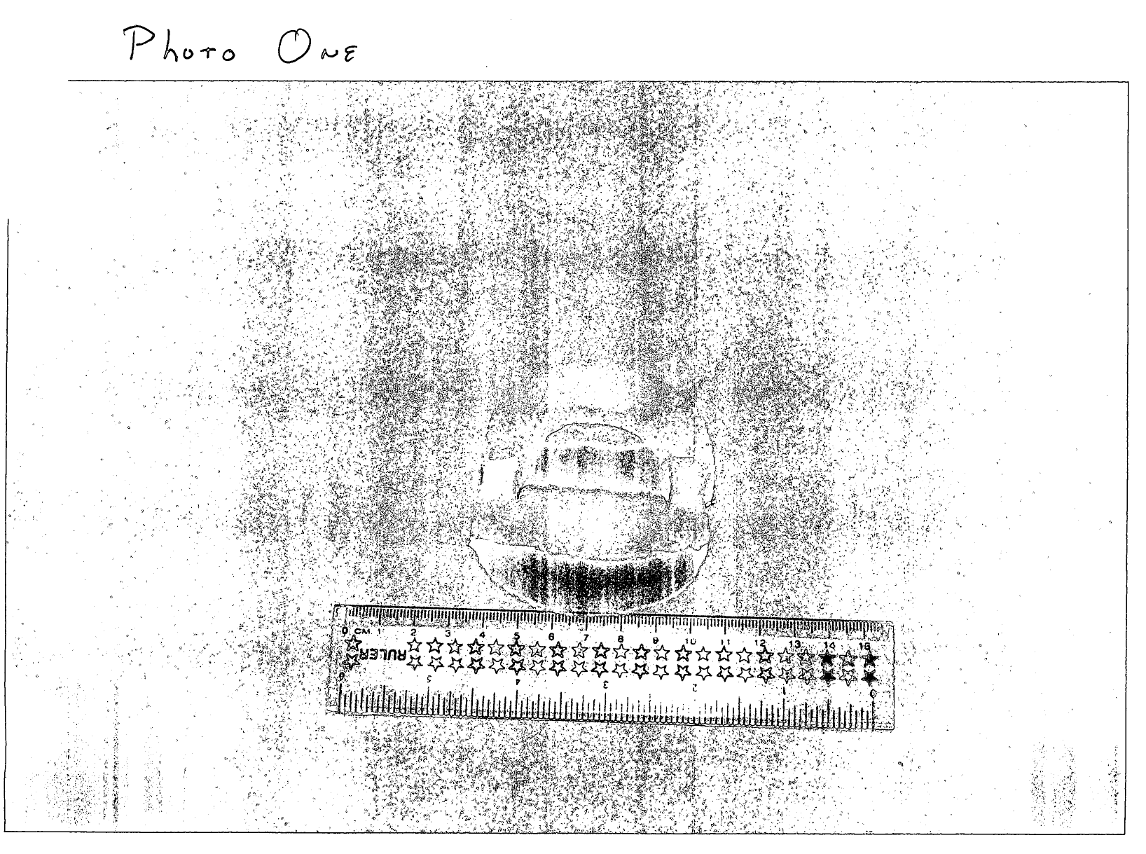

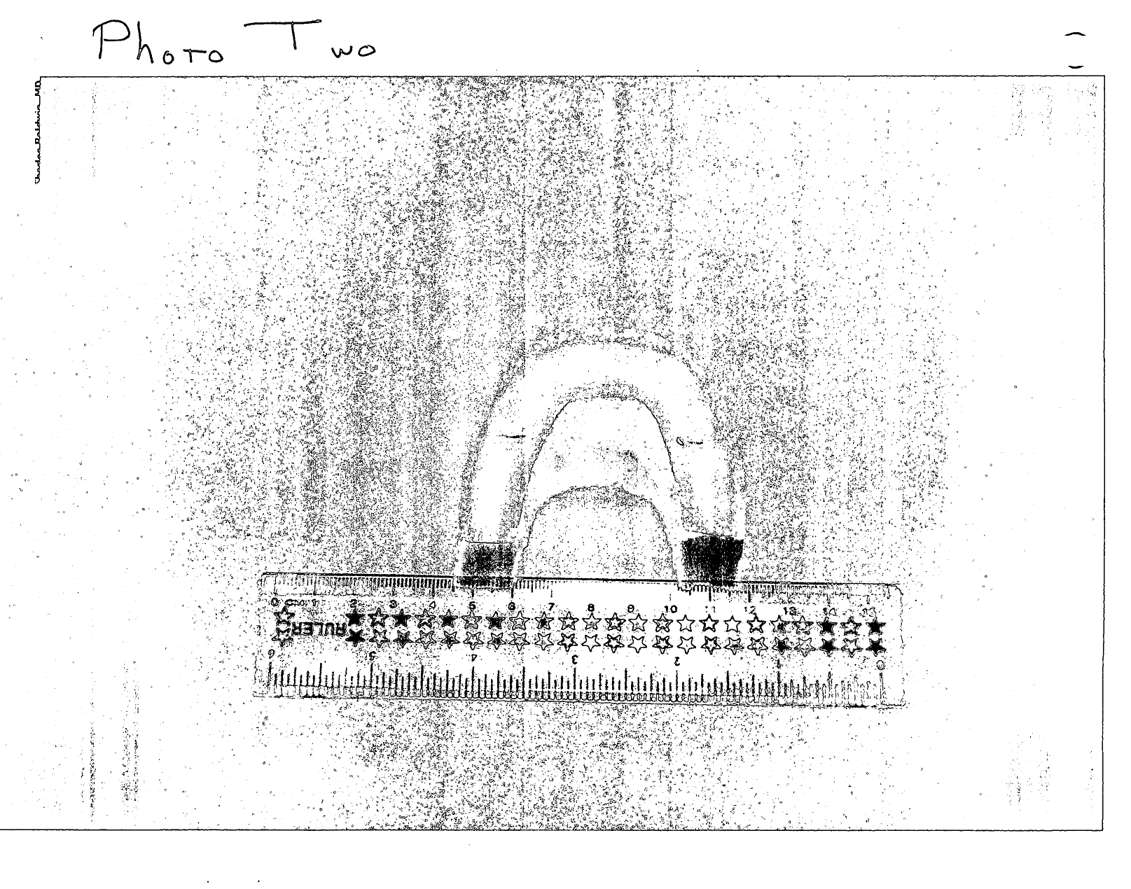

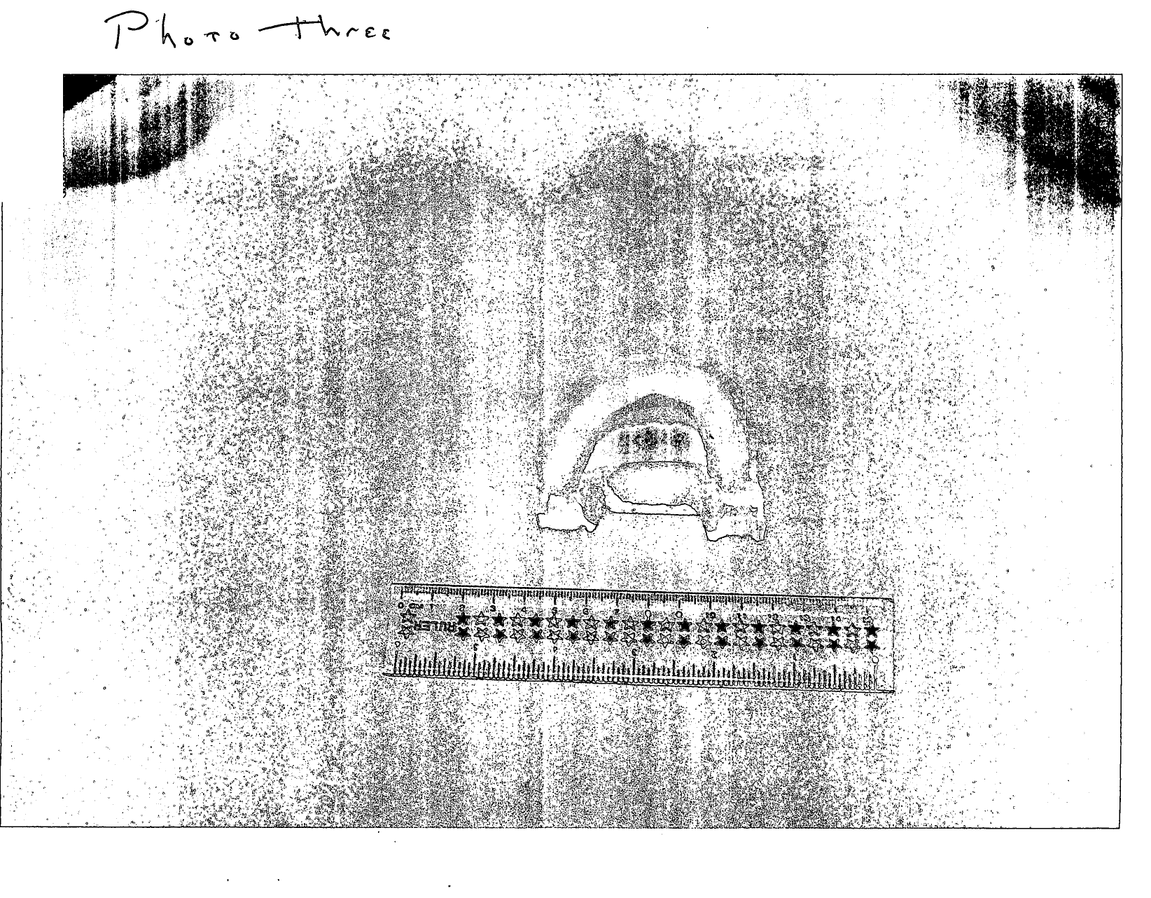

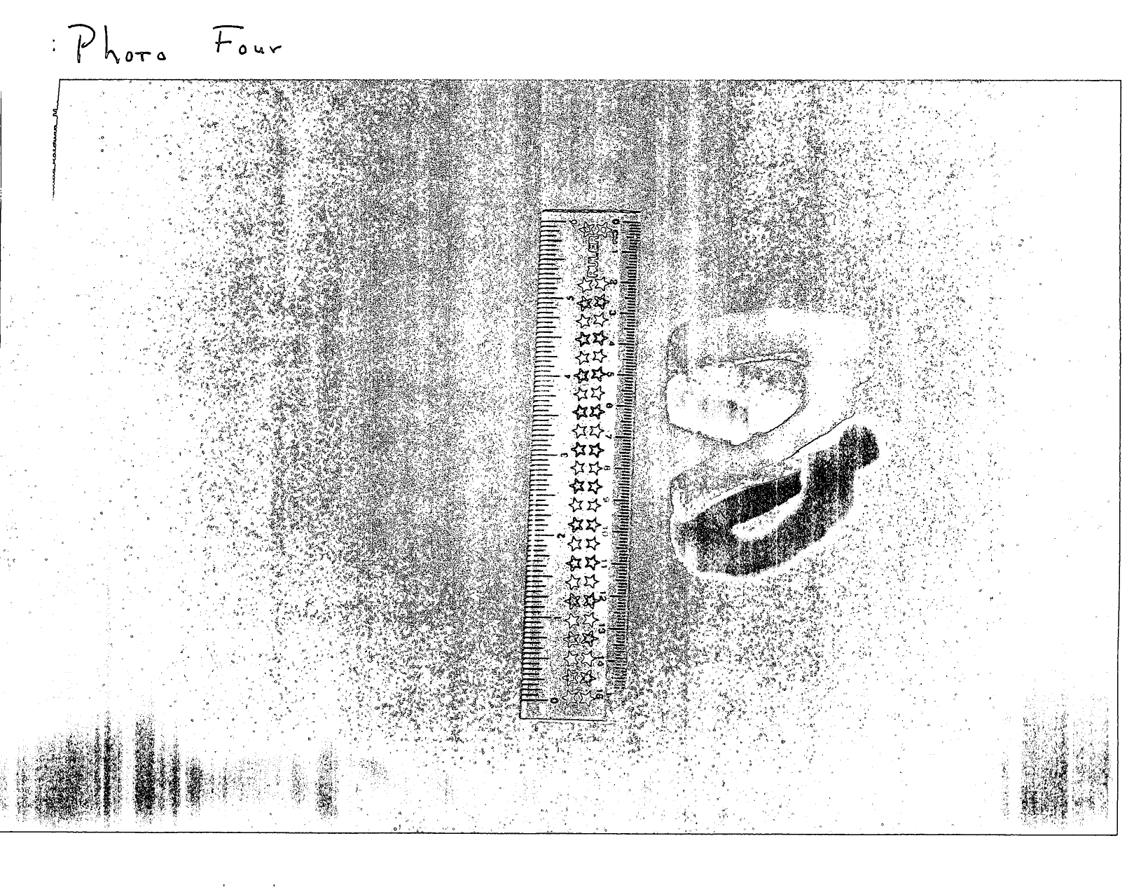

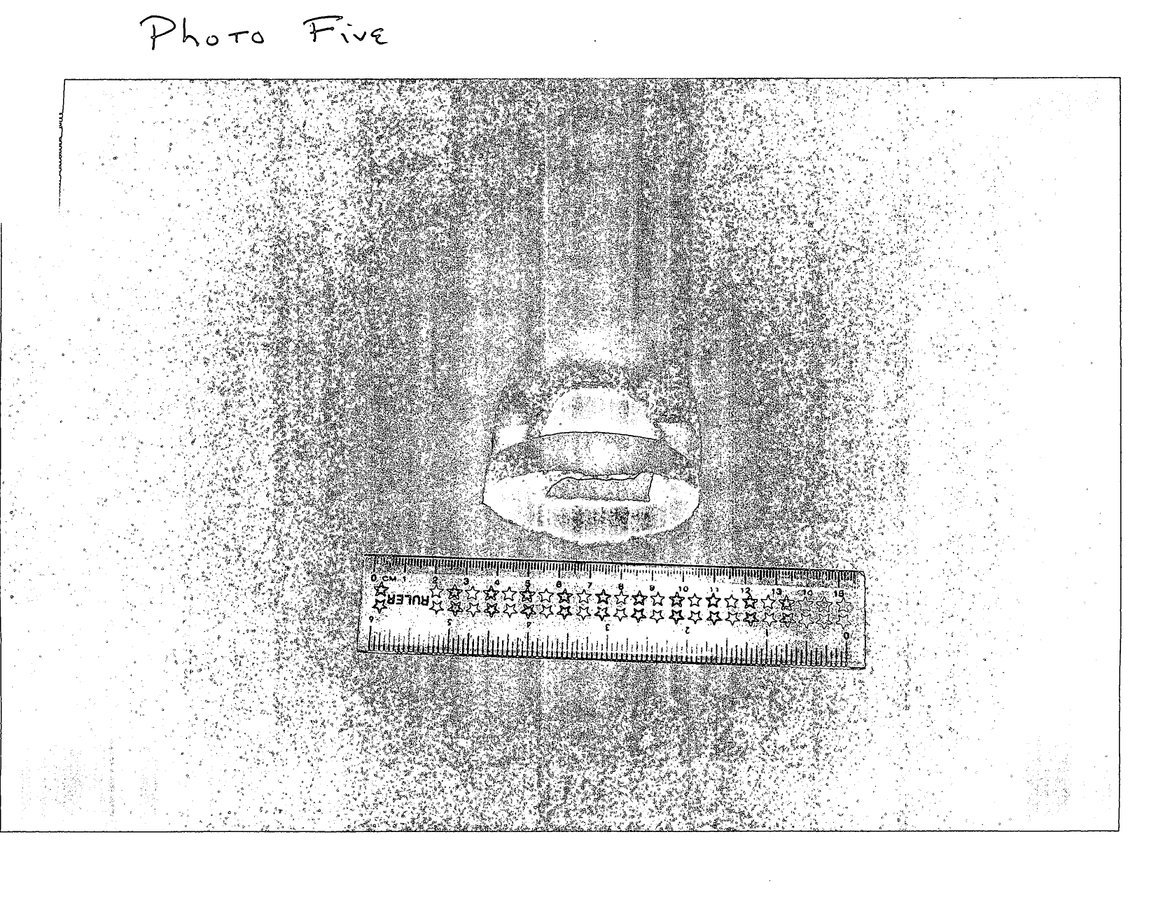

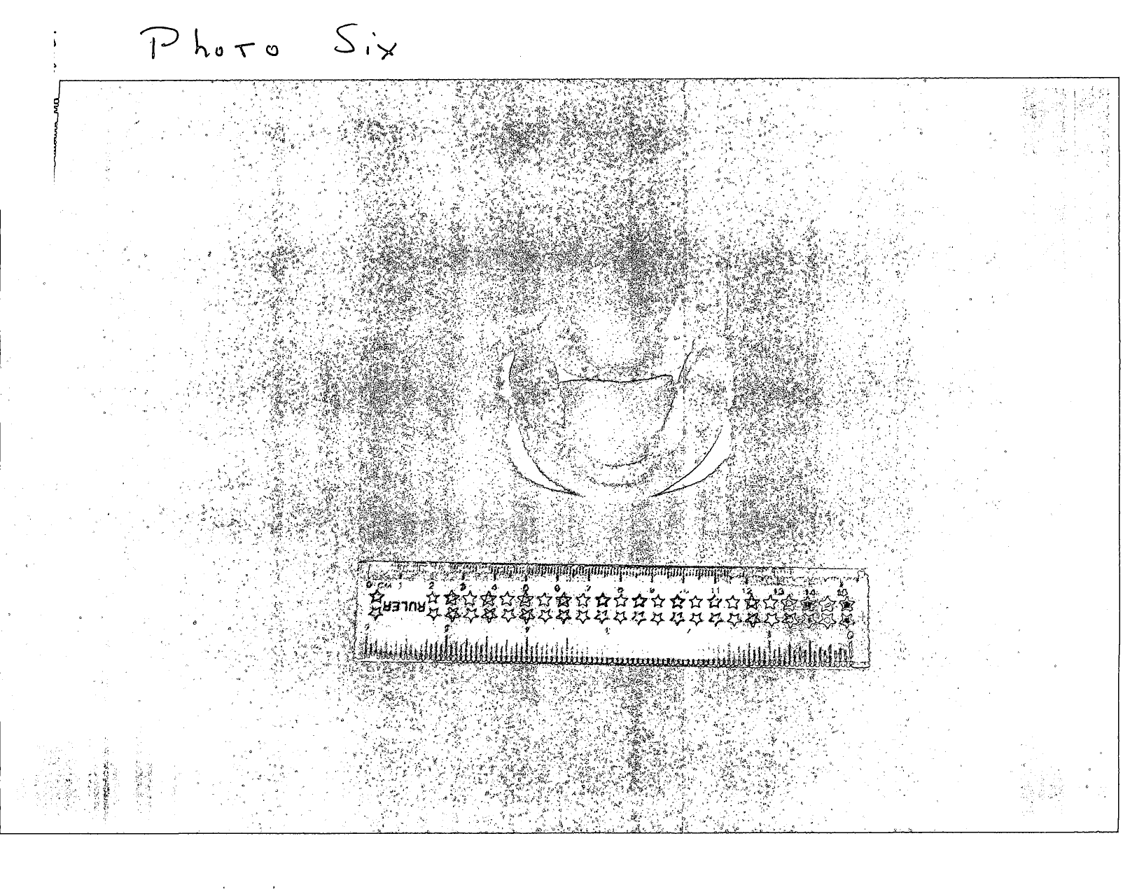

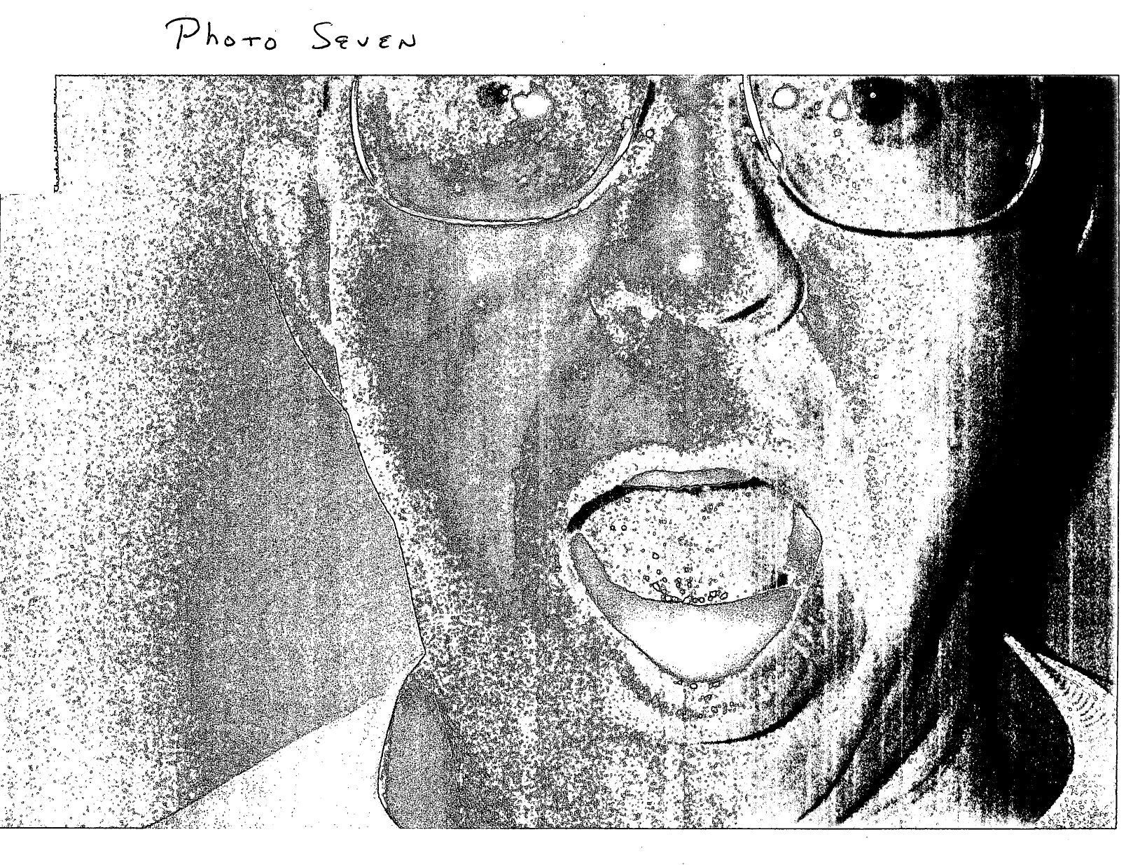

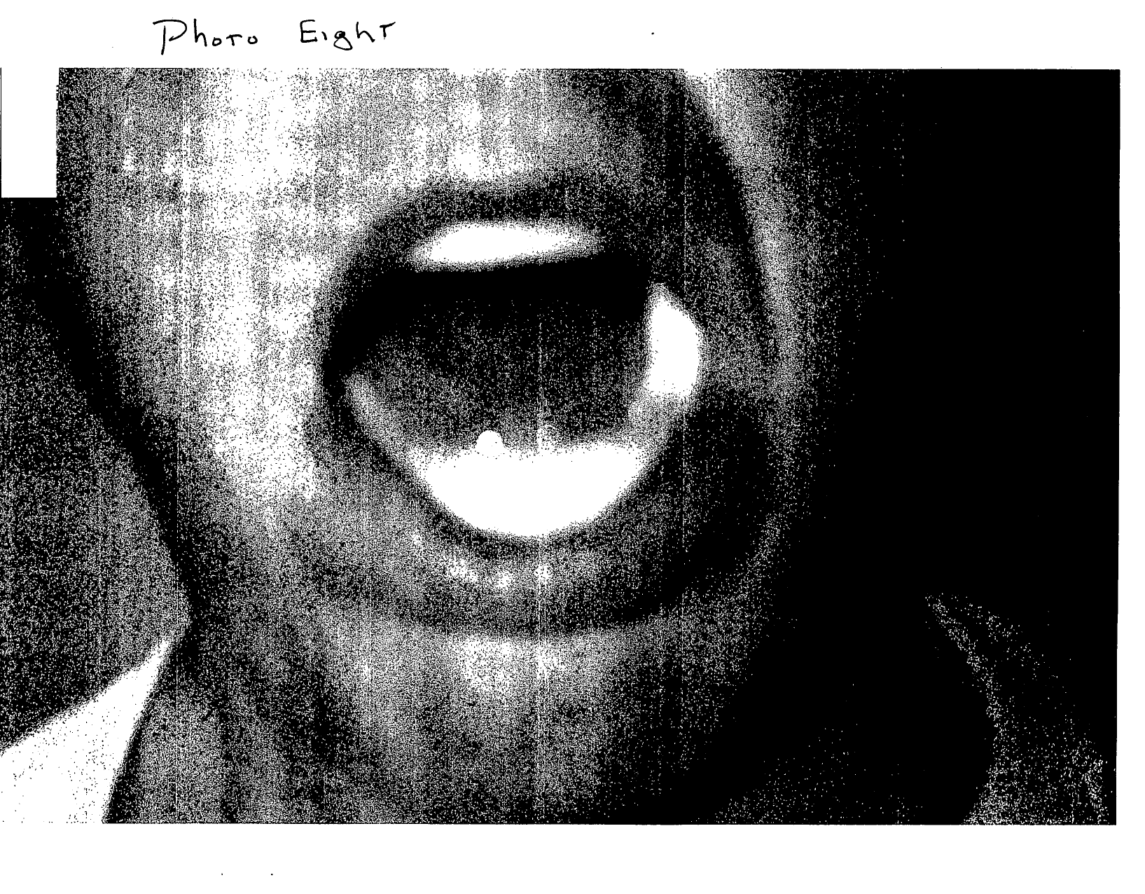

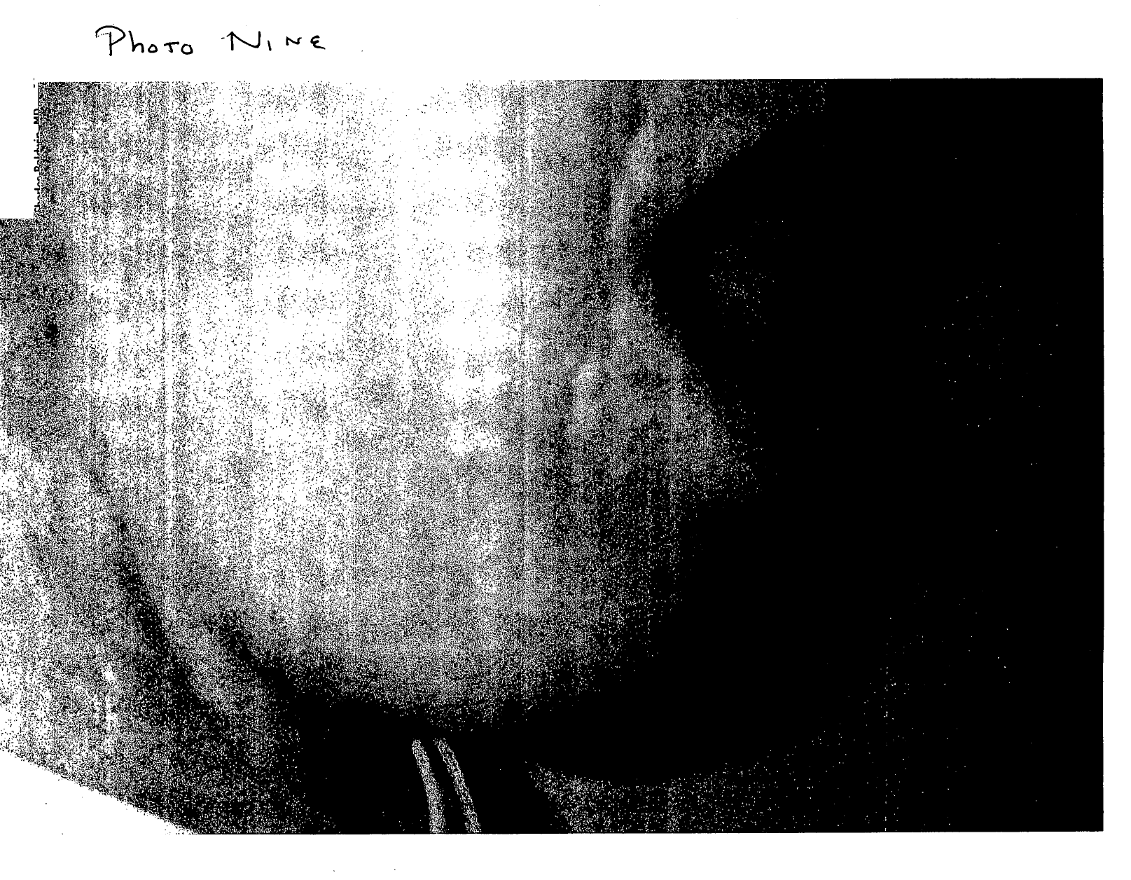

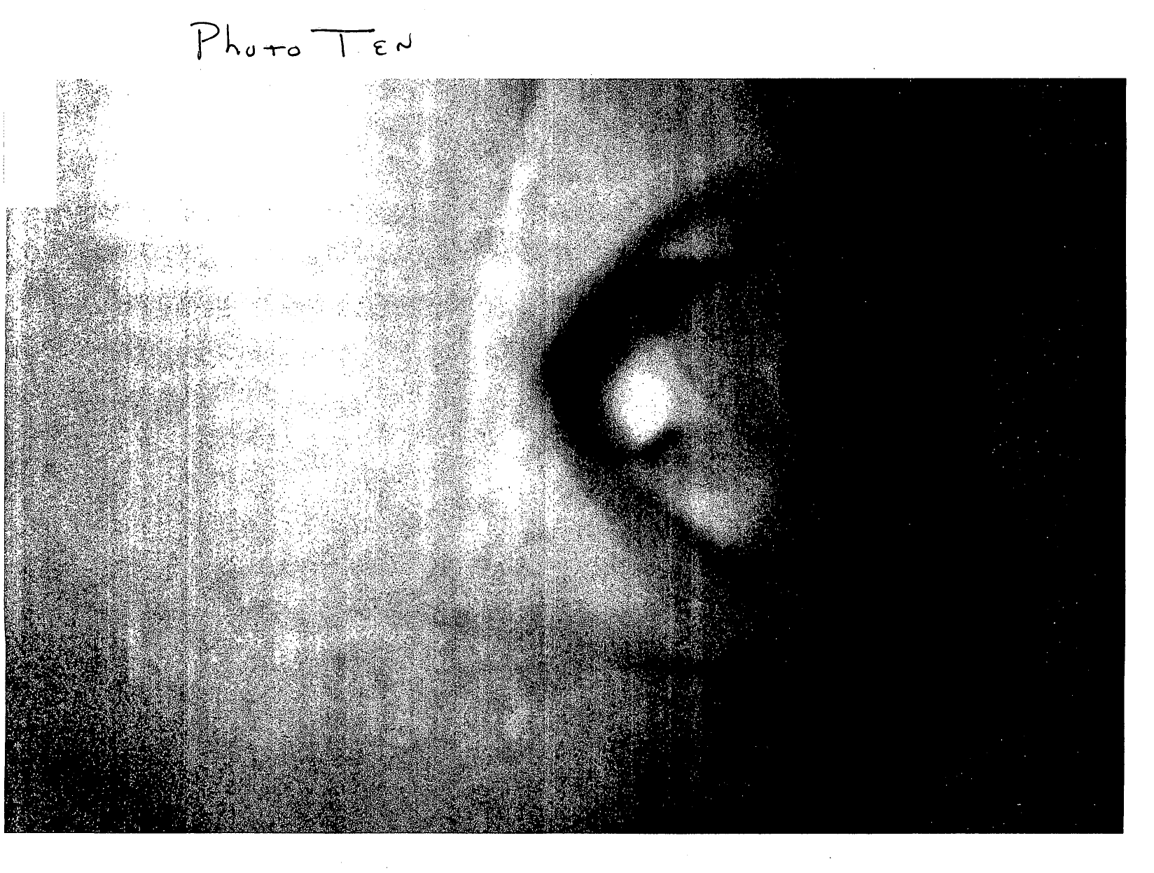

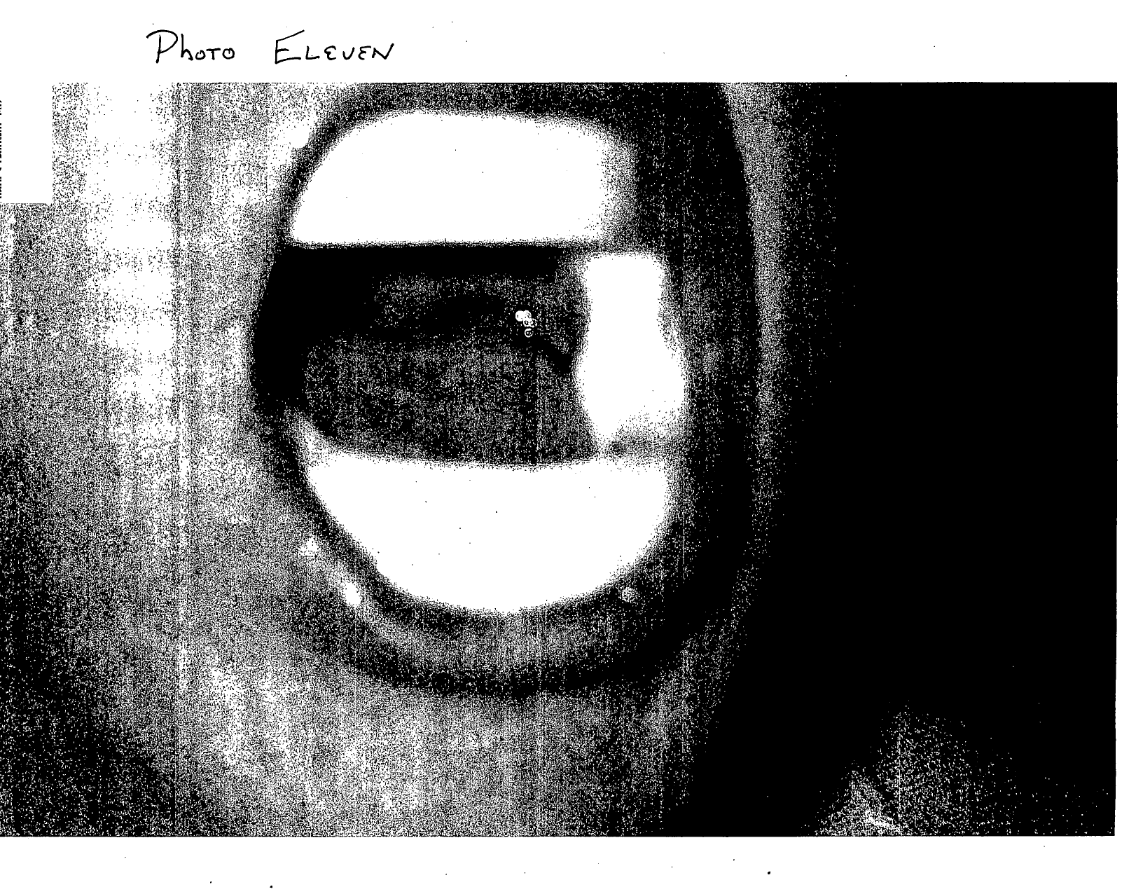

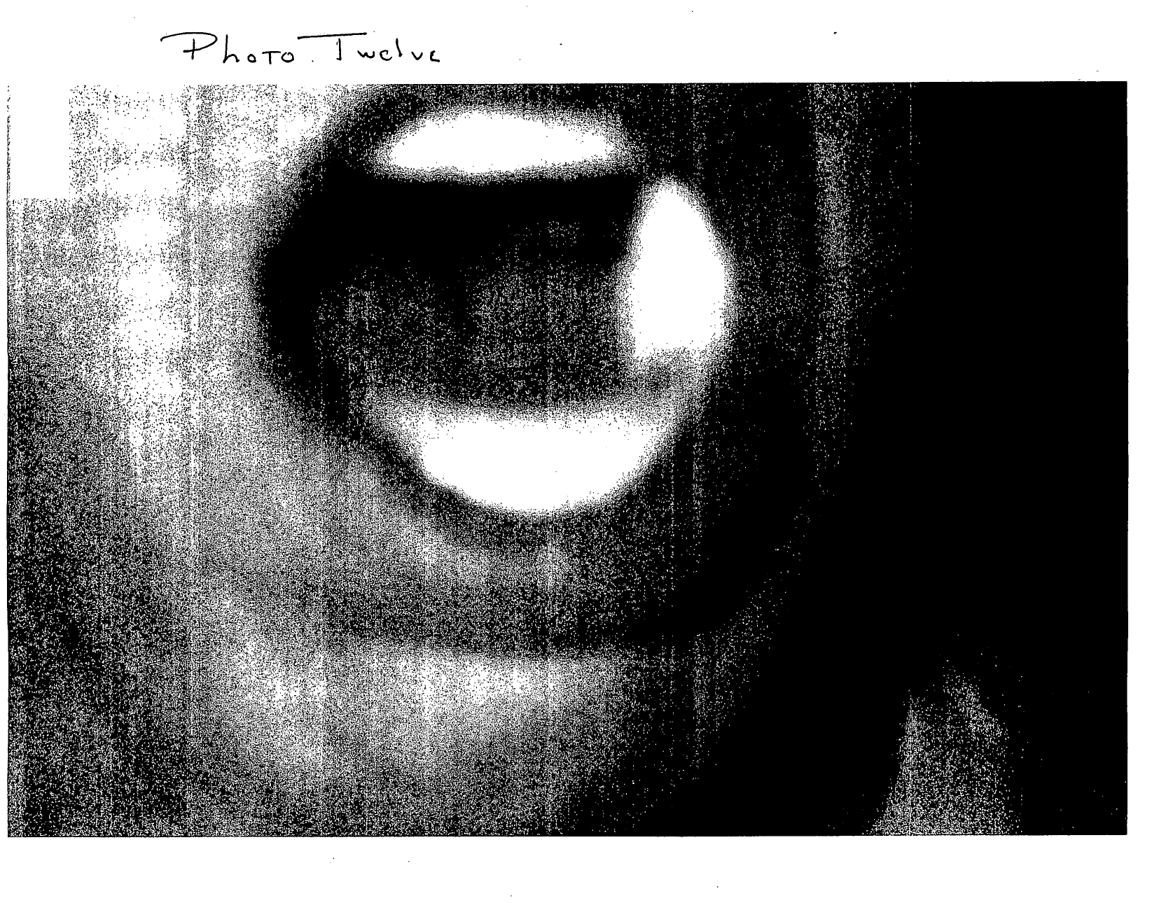

The Awake Airway is an oral device designed to fit over the dental arches or alveolar ridges of both the maxilla and mandible with a connecting buttress. The buttress maintains the distance between the two arches as well as provides for easy passage for diagnostic devices such as endoscopes or bronchoscopes. Moreover, it provides an opening for such other more invasive airway devices as endotracheal tubes and laryngeal mask airways (LMAs). An angle less than 20 degrees between the two arches seems comfortable, and versions with more or less angular opening are possible, though the largest opening comfortably tolerated probably has the most benefit.

The central idea of the device is to have no component that touches any part of the oral cavity or oropharynx in such a way as to gag or noxiously stimulate the wearer. Consequently it should fit comfortably and could be used in the fully awake and aroused person. It is this non-stimulating feature of the design for which we are applying for a utility patent.

The Awake Airway can be used in the sedated, anesthetized, or obtunded patient as well. Unlike other airway support devices such as the oropharyngeal (OP) or nasopharyngeal (NP) airways it could be placed at the beginning of a procedure when the patient is awake. Conversely, it could then be left in until the end of the procedure and the patient is fully aroused and awake again.

It might be useful in patients with respiratory compromise but too awake to tolerate other more invasive devices. The might help avoid intubation and ventilatory support in such patients, particularly combined with such therapies as Continuous Positive Airway Pressure (CPAP) and non-rebreathing masks to deliver very high oxygen flows.

Because of it's awake tolerability and open airway affect, the Awake Airway might find a place in managing such conditions as Obstructive Sleep Apnea (OSA), which is becoming more prevalent with the increasing obesity and aging of the population as well as a result of increased awareness which leads to more case discoveries.

### LINKED APPLICATIONS

This application is linked to three other utility patent applications and one design patent application:

The design application is for the unique, and readily recognizable appearance of the Awake Airway, including all it's variants.

The three other utility applications are:

1) Mandibular thrust or advancement in the design to open the airway by sliding the mandibular condyle anteriorly in the temporomandibular joint, emulating the jaw thrust maneuver.

2) A glossal variant incorporating a tongue arch on the mandibular component to hold the tongue in place without gagging the patient, enhancing airway patency.

3) The addition of a manual attachment similar to a zip tie to the maxillary arch to anchor the more invasive airways like endotracheal tube, enhancing their stability and position.

### ATTACHMENTS TO THIS APPLICATION

Figure One: Design graphic for a large version of the Awake Airway.

Figure Two: Drawings of two versions of the Awake Airway: With and Without Teeth (edentulous).

Photos one thru six: Photos of rough large prototype of the Awake Airway

Photos seven thru twelve: The large rough prototype of the Awake Airway in place in the mouth.

I claim:

1. A parabolic arch shaped support to gently and firmly grasp the maxillary dental arch; the support covering from the incisor teeth to the molar teeth or, for the edentulous, the entire maxillary alveolar arch; the support comprised of a resilient and firm material molded into a cross-sectional u-shape;
An outside (buccal) edge or lip and inside (lingual) edge or lip comprising the two sides of the cross sectional u-shape.

2. a second support of softer foam material inserted into said first support in claim 1 to cushion and gently hold the dental arch or alveolar ridge

3. a second support arch as claimed in claim 2 to also have a parabolic arch shaped to follow the maxilla.

4. a second support arch as claimed in claim 2 to have cross section u-shape to form a channel following the parabolic arch shape of the support to hold the teeth gently.

5. a second support arch as claimed in claim 2 to have two differing cross sectional thicknesses to accommodate teeth and/or dentures in the thinner version, or the edentulous alveolar ridge in the thicker version.

6. the floor or bottom of the cross sectional u shape as claimed in claim 1 to be narrow at the peak of the arch to accommodate the incisor teeth, widening toward both legs of the arch, maximum at the edge to accommodate the molar teeth/or wider alveolar ridge.

7. a second support as claimed in claim 2 to also be narrower at the peak of the arch (incisor teeth) and wider toward both bases (molar teeth) inserted in the channel of the support arch as claimed in claim 1.

8. an outside (buccal) lip as claimed in claim 1 to be angled a few degrees (circa 15) degrees) posteriorly from a vertical from the base of the support as claimed in claim one

9. an outside buccal lip as claimed in claim 1 to have the angle from the base of the support approach back to vertical as it is molded toward the molar teeth.

10. an outside buccal lip or edge as claimed in claim 1 to be sufficiently high to cover the incisor teeth at the apex of the arch of the support.

11. an outside buccal lip or edge as claimed in claim 1 to taper in height so that it just covers the molar teeth (usually lower than the height of incisor teeth).

12. a second support arch as claimed in claim 2 to taper in height from the incisor lip or edge to the molar lip or edge.

13. an inside (lingual) lip as claimed in claim 1 to be angled a few degrees (circa 15 degrees) posteriorly from a vertical from the base of the support as claimed in claim one

14. an inside (lingual) lip as claimed in claim 1 to have the angle from the base of the support rotate back to vertical as it is molded toward the molar teeth.

15. an inside (lingual) lip or edge as claimed in claim 1 to be sufficiently high to cover the incisor teeth at the apex of the arch of the support.

16. an inside (lingual) lip or edge as claimed in claim 1 to taper in height so that it just covers the molar teeth (usually lower than the height of incisor teeth).

17. a second support arch as claimed in claim 2 to taper in height from the incisor lip or edge to the molar lip or edge.

18. An inside (lingual) lip or edge as claimed in claim 1 to be shorter than the outside (buccal) lip or edge to better conform to the angle of the mucosa arising from the lingual edge of the incisor teeth.

19. An inside (lingual) lip or edge as claimed in claim 1 to taper more that the outside (buccal) lip or edge to accommodate the fuller and flatter angle of the lingual mucosa.

20. a buttress or arch molded in the support as claimed in claim 1 to be affixed to another support arch symmetric but reversed 180 degrees from the support as claimed in claim 1 to gently grasp the mandibular dental arch so as to hold the two arches angled open from one another.

22. a buttress or arch as claimed in claim 20 to be molded into the molar (base of arch) portions of the arch shaped support, extending forward toward the premolars.

23. a buttress or arch as claimed in claim 20 to not be molded beyond the edge of the support, but to be smoothly tapered in all planes so as to have no edges, just a molded surface.

24. a buttress or arch as claimed in claim 20 to have an oval to rounded rectangular cross sectional shape at all levels including its attachment to the underside of the alveolar arch support.

25. a buttress or arch as claimed in claim 20 to angle the two alveolar arch support to obtain an opening of more than a centimeter and/or an angle of 15 degrees and maintain tem in that relationship.

26. A parabolic arch shaped support to gently and firmly grasp the mandibular dental arch; the support covering from the incisor teeth to the molar teeth or, for the edentulous, the entire maxillary alveolar arch; the support comprised of a resilient and firm material molded into a cross-sectional u-shape;
An outside (buccal) edge or lip and inside (lingual) edge or lip comprising the two sides of the cross sectional u-shape.

27. a second support of softer foam material inserted into said first support in claim 26 to cushion and gently hold the dental arch or alveolar ridge

28. a second support arch as claimed in claim 27 to also have a parabolic arch shaped to follow the maxilla.

29. a second support arch as claimed in claim 27 to have cross section u-shape to form a channel following the parabolic arch shape of the support to hold the teeth gently.

30. a second support arch as claimed in claim 27 to have two differing cross sectional thicknesses to accommodate teeth and/or dentures in the thinner version, or the edentulous alveolar ridge in the thicker version.

31. the floor or bottom of the cross sectional u shape as claimed in claim 26 to be narrow at the peak of the arch to accommodate the incisor teeth, widening toward both legs of the arch, maximum at the edge to accommodate the molar teeth/or wider alveolar ridge.

31. a second support as claimed in claim 27 to also be narrower at the peak of the arch (incisor teeth) and wider toward both bases (molar teeth) inserted in the channel of the support arch as claimed in claim 1.

32. an outside (buccal) lip as claimed in claim 26 to be angled a few degrees (circa 15 degrees) posteriorly from a vertical from the base of the support as claimed in claim one

33. an outside buccal lip as claimed in claim 26 to have the angle from the base of the support approach back to vertical as it is molded toward the molar teeth.

34. an outside buccal lip or edge as claimed in claim 26 to be sufficiently high to cover the incisor teeth at the apex of the arch of the support.

35. an outside buccal lip or edge as claimed in claim 26 to taper in height so that it covers the molar teeth (usually lower than the height of incisor teeth).

36. a second support arch as claimed in claim 27 to taper in height from the incisor lip or edge to the molar lip or edge.

37. an inside (lingual) lip as claimed in claim 26 to be angled a few degrees (circa 15 degrees) posteriorly from a vertical from the base of the support as claimed in claim one

38. an inside (lingual) lip as claimed in claim 26 to have the angle from the base of the support rotate back to vertical as it is molded toward the molar teeth.

39. an inside (lingual) lip or edge as claimed in claim 26 to be sufficiently high to cover the incisor teeth at the apex of the arch of the support.

40. an inside (lingual) lip or edge as claimed in claim 26 to taper in height so that it just covers the molar teeth (usually lower than the height of incisor teeth).

41. a second support arch as claimed in claim 27 to taper in height from the incisor lip or edge to the molar lip or edge.

42. An inside (lingual) lip or edge as claimed in claim 26 to be shorter than the outside (buccal) lip or edge to better conform to the angle of the mucosa arising from the lingual edge of the incisor teeth.

43. An inside (lingual) lip or edge as claimed in claim 26 to taper more that the outside (buccal) lip or edge to accommodate the fuller and flatter angle of the lingual mucosa.

44. a buttress or arch molded in the support as claimed in claim 26 to be affixed to another support arch symmetric but reversed 180 degrees from the support as claimed in claim 1 to gently grasp the maxillary dental arch so as to hold the two arches angles open from one another.

45. a buttress or arch as claimed in claim 44 to be molded into the molar (base of arch) portions of the arch shaped support, extending forward toward the premolars.

46. a buttress or arch as claimed in claim 44 to not be molded beyond the edge of the support, but to be smoothly tapered in all planes so as to have no edges, just a molded surface.

47. a buttress or arch as claimed in claim 44 to have an oval to rounded rectangular cross sectional shape at all levels including its attachment to the underside of the alveolar arch support.

48. a buttress or arch as claimed in claim 44 to angle the two alveolar arch support to obtain an opening of more than a centimeter and/or an angle of 15 degrees and maintain tem in that relationship.

49. two arch supports as claimed in claim 1 and claim 26 and a buttress or arch as claimed in claim 20 and claim 44 together to gently mold and grasp the maxilla and mandible and keep the mouth gently but firmly opened without touching any oral or pharyngeal structures that would gag or stimulate the wearer
